(19) United States
(12) Patent Application Publication
(10) Pub. No.: US 2016/0004980 A1
(43) Pub. Date: Jan. 7, 2016

(54) SYSTEMS AND METHODS FOR GENERATING MODELS FOR PHYSICAL SYSTEMS USING SENTENCES IN A FORMAL GRAMMAR

(71) Applicant: OspreyData, Inc., San Juan Capistrano, CA (US)

(72) Inventor: Oren Goldschmidt, Laguna Niguel, CA (US)

(21) Appl. No.: 14/856,464

(22) Filed: Sep. 16, 2015

Related U.S. Application Data
(63) Continuation of application No. 14/716,666, filed on May 19, 2015.
(60) Provisional application No. 62/000,113, filed on May 19, 2014.

(51) Int. Cl. G06N 99/00; G06F 17/28; G06N 5/04; G06F 17/27

(52) U.S. Cl. CPC G06N 99/005; G06F 17/274; G06F 17/28; G06N 5/04

(57) ABSTRACT

A human expert creates sentences in a formal grammar to describe the state of a physical system through aspects of the behavior of such systems. A software process combines these sentences with historical data about physical systems of the same type and uses machine learning to generate a model that detects this state in such systems. These models are able to detect important states of physical systems, such as states that are predictive of future failures, without needing precise guidance from a human user.

This application is a continuation of U.S. application Ser. No. 14/716,666, filed May 19, 2015, which claims the benefit of priority to U.S. Provisional Application No. 62/000,113, filed May 19, 2014, the contents of which are incorporated by reference in their entireties. Where a definition or use of a term in a reference that is incorporated by reference is inconsistent or contrary to the definition of that term provided herein, the definition of that term provided herein is deemed to be controlling.

### FIELD OF THE INVENTION

The field of the invention is machine learning technology.

### BACKGROUND

The background description includes information that may be useful in understanding the present invention. It is not an admission that any of the information provided herein is prior art or relevant to the presently claimed invention, or that any publication specifically or implicitly referenced is prior art.

Physical systems including but not limited to industrial plant, power generation equipment, oil field equipment, and transportation systems, are prone to unexpected failure and inefficient operation. Such equipment is often provided with sensors which generate data that can be used to improve performance and predict impending failure.

Existing techniques for developing sophisticated models for these systems in order to predict failure far in advance and to optimize performance require extensive development effort either through the direct development of new algorithms or through the use of statistical modeling tools such as ‘SPSS’ or ‘SAS’. As such, existing methods are rarely used and cannot be deployed to deal with performance optimization and failure prediction where extensive development or modeling work is not cost effective or where resources for such work are in short supply.

A technique which allows human users familiar with the physical systems to build models using a more expressive paradigm would enable a significant reduction in the cost and effort required to build new models, allowing such models to be developed for the many classes of physical systems for which existing techniques have not been applied due to cost or resource constraints.

### SUMMARY OF THE INVENTION

The present invention provides apparatus, systems, and methods for detecting the state of a physical system through the novel application of language processing and machine learning.

The states to be detected may include states that arise in advance of a failure of the system to be monitored and hence are predictive of a failure. Such states, when detected by the system, can be used to alert users of the system to perform preventative maintenance, ensure replacement parts or systems are available, or change the operating parameters of the system to delay or prevent the failure.

The states to be detected may also include operating conditions that result in suboptimal efficiency of the system. In this case, detection of these states may be used to alert users of the system to alter the operating parameters of the system or take other action to ensure that the system is operating optimally.

Some aspects of the inventive subject matter provides for a technique, GAME (Grammar-Augmented Modeling Environment), for creating models for detecting the state of a physical system through the novel application of language processing and machine learning.

This technique allows human users to develop models for physical systems by interacting with a computer program in a familiar subset of a natural language (such as English, French, etc.) rather than requiring them to use a computer language (such as ‘R’) or to use a complex modeling tool (such as ‘SAS’ or ‘SPSS’). Furthermore, through the use of machine learning the present technique operates on indefinite instructions from the human user rather than requiring a precise definition of the properties of the final model.

In GAME, a formal grammar is used to describe a subset of the natural (human) language to be used for modeling. The formal grammar consists of a set of production rules that specify which sentences can be expressed by the user. This will consist of a small subset of all possible sentences in the natural language. The grammar allows users of GAME to build sentences interactively to describe patterns in the behavior of physical systems.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 illustrates an operating environment for a prediction model system.

FIG. 2 illustrates an example of associating a data pattern model object with a description input.

FIG. 3 illustrates a process of using an improved machine learning algorithm to generate a prediction model.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

As used in the description herein and throughout the claims that follow, when a system, engine, or a module is described as configured to perform a set of functions, the meaning of “configured to” or “programmed to” is defined as one or more processors being programmed by a set of software instructions to perform the set of functions.

One should appreciate that the disclosed modeling system provides numerous advantageous technical effects, especially in the field of machine learning. For example, the modeling system of some embodiments enables accurate and efficient recognition of patterns relevant to the states of a particular physical system, by using a formal language to improve the machine learning algorithm.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

In one aspect of the inventive subject matter, systems and methods for improving accuracy and efficiency of machine learning are presented. In some embodiments, the system improves the accuracy and efficiency of machine learning by using a formal language to assist in identifying data patterns that are relevant to a particular physical system. The improved machine learning can be applied to generate prediction model for complex physical systems.

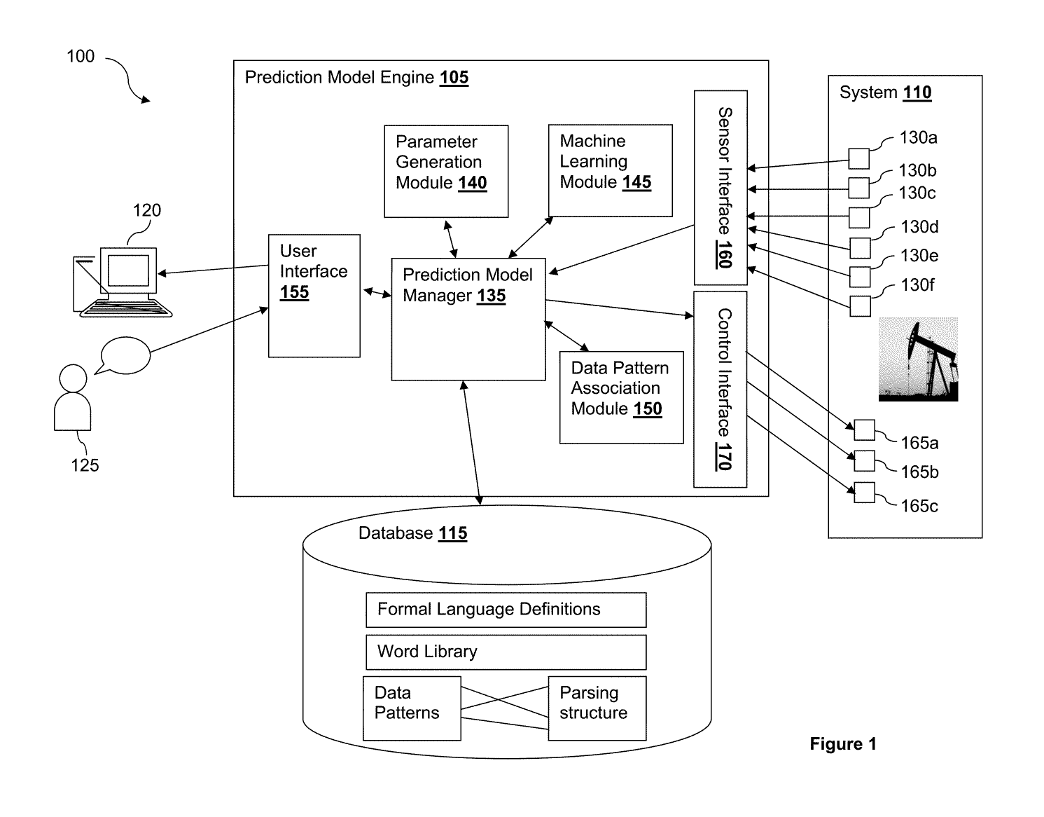

FIG. 1 illustrates an operating environment 100 of such a system. The operating environment 100 includes a prediction model engine 105, a physical system 110, a database 115, a user interface 120, and a subject matter expert 125. Preferably, physical system 110 is a complex system that includes numerous devices working together to perform certain tasks. Examples of such a complex physical system include an oil and refinery system, a construction site, a human body, or other system with similar complexities. In some embodiments, physical system 110 includes multiple sensor modules (e.g., sensor modules 130a-130f). Each of the sensor modules (130a-130f) includes a sensor for detecting an environmental value (e.g., temperature, pressure, speed, orientation, acceleration, oxygen level, blood sugar level, etc.) related to the well-being of an element within physical system 110. The sensors can include different types of sensors such as temperature sensor, pressure sensor, speedometer, accelerometer, oxygen sensor, blood sugar detector, etc.

The subject matter expert 125 is a human expert who has expertise in the operation of physical system 110. Preferably, the subject matter expert 125 is capable of identifying a state or condition of physical system 110 (e.g., high likelihood of failure, part wearing out soon, etc.) upon studying the sensor data obtained from sensor modules 130a-130f.

Prediction model engine 105 includes a prediction model manager 135, a parameter generation module 140, a machine learning module 145, a data pattern association module 150, a user interface 155, and a sensor interface 160. Prediction model engine 105 is also communicatively coupled with database 115.

It is contemplated that a formal language is developed to describe different patterns of the sensor data retrieved from sensor modules 130a-130f. In some embodiments, the formal language is designed to be universal and can be used for different types of physical system 110, while in other embodiments, the formal language is designed to work specifically with a particular physical system 110. When the formal language is designed to work specifically with a particular physical system (e.g., physical system 110), the word library of the formal language can be more specific and tailored to that physical system. For example, if the physical system is an oil refinery system, the word library can include words such as pressure, temperature, etc. In addition, with the help of the subject matter expert 125, the formal language definitions can indicate possible relationship between different words. For example, the formal language definitions can include an association between pressure and temperature so that one can form a phrase under the definitions to describe the relationship between the pressure and the temperature (e.g., “pressure rises as temperature drops,” etc.).

Once the formal language is developed, the definitions of the formal language are obtained by prediction model engine 105 and stored in database 115. It is noted that the definitions of the formal language define how phrases can be formed using the formal language. Similarly, the definitions can also be used by prediction model engine 105 to parse a phrase provided via user interface 120.

In some embodiments, prediction model engine 105 is programmed to generate different data pattern template models for describing different types of data patterns. For example, prediction model engine 105 is programmed to generate a saw-tooth pattern template model for describing a saw-tooth data pattern, a spike template model for describing a spike data pattern, a sudden change template model for describing a data pattern that suddenly increases or decreases, and any other template models for describing other known patterns.

Using the formal language definitions, prediction model engine 105 is programmed to make associations between different phrases and different data pattern template models. In some embodiments, prediction model engine 105 uses a parsing structure such as a tree structure (e.g., a K-D tree, etc.) in parsing phrases and then associating the phrase with a data pattern template model (i.e., a data pattern type). In these embodiments, each node in the tree represents a different word that is part of the formal language. The connections between the nodes are generated by prediction model engine 105 using the formal language definitions. A connection between two nodes represents a possibility that a phrase consists of the two words corresponding to the two nodes next to each other according to the formal language definitions. In the embodiments where the connection also includes a direction, the direction signifies the order in which the two words appear in the phrase.

Once prediction model engine 105 has obtained the formal language definitions and created the parsing structure, prediction model manager 135 is programmed to begin retrieving sensor data from sensor modules 130a-130f of physical system 110 via sensor interface 160. In some embodiments, prediction model manager 135 is programmed to repetitively and periodically (e.g., every second, every minute, every hour, etc.) retrieving sensor data from sensor modules 130a-130f over a period of time.

As prediction model manager 135 is retrieving new sensor data from sensor modules 130a-130f, prediction model manager 135 is programmed to present the retrieved sensor data on a display device (e.g., computer 120) via user interface 155 for a subject matter expert (e.g., subject matter expert 125) to view. In some of these embodiments, prediction model manager 135 is programmed to present the sensor data in real-time (e.g., within 3 seconds of retrieving the data). In addition, prediction model manager 135 is programmed to present the sensor data over a period of time in a graphical form. For example, sensor data retrieved from the same sensor module can be used to generate a graph (e.g., a line graph, etc.) for presentation.

As the sensor data is being presented at computer 120, prediction model manager 135 is programmed to prompt subject matter expert 125 (via computer 120) for description input (e.g., verbal input, etc.) that describes the sensor data being displayed. In some embodiments, prediction model manager 135 is programmed to instruct subject matter expert 125 to provide input only to the portions of sensor data that subject matter expert 125 believes are significant to the well-being of physical system 110 (e.g., parts wearing out soon, indication of system failure soon, etc.).

In addition, prediction model manager 135 is also programmed to provide an interface (via user interface module 155) that enables subject matter expert 125 to select a portion of the sensor data displayed on computer 120, such that as prediction model manager 135 receives description input from subject matter expert 125, prediction model manager 135 is programmed to use data pattern association module 150 to associate the description input with the portion of sensor data being displayed on computer 120 (or selected by subject matter expert 125).

Upon receiving the description input, data pattern association module 150 is programmed to parse the input using the parsing structure stored in database 115. The parsing of the input should result in either an indication of an invalid phrase or an association with a data pattern template model. In the event that the phrase is determined to be invalid according to the formal language definitions, prediction model manager 135 is programmed to send a signal to computer 120 to display an error message. Conversely, if the phrase is associated with one of the data pattern template models stored in database 115, data pattern association module 150 is programmed to instantiate a new instance of the data pattern model and then add the information derived from the portion of the sensor data to the newly instantiated data pattern model.

Prediction model engine 105 is programmed to continuously present updated sensor data and repetitively collect description input from subject matter expert 125 and instantiate new data pattern model over a period of time. Based on the information from the instantiated data pattern models, parameter generation module 140 is programmed to estimate parameters that can be fed into machine learning module 145 for more efficient machine learning performance over the data set obtained from sensor modules 130a-130f.

In generating When instantiating a new data pattern model from a data pattern template, for example a sawtooth pattern template, parameter generation module 140 needs to specify the parameters of that pattern. These parameters define the characteristics of the pattern to be detected. For example, with a sawtooth pattern, the range of amplitudes and frequencies of the waveforms to be detected and their offset from zero. In some embodiments, these parameters are set by the user and be incorporated into the data pattern template. In other embodiments, parameter generation module 140 will create initial estimates for the parameters by examining the waveform selected by the human expert. For example, in the case of a sawtooth pattern template, parameter generation module 140 will examine a historical waveform labeled by the human expert as being a sawtooth and determine the range of amplitudes, frequencies, and offsets of the highlighted waveform to use as initial estimates of these parameters. In some embodiments, parameter generation module 140 is also programmed to optimize the parameters for the instantiated data pattern models. Once the parameters are estimated, prediction model manager 135 is programmed to feed the parameters along with the data set retrieved from sensor modules 130a-130f over a period of time (the “collective dataset”) to machine learning module 145. Since parameter estimation relies on one or a small number of examples, the parameters may not be sufficiently accurate. The machine learning module 145 starts with the estimated parameters and continuously optimizes them using new dataset and input from the human expert so that their accuracy is improved. Machine learning techniques such as adaptive gradient descent and simulated annealing are used to optimize the parameters. Optimization relies on historical data (the “collective dataset”) which includes information on any failure or suboptimal performance events. The machine learning module 145 optimizes the parameters by looking at a mixture of historical datasets at times and on assets where the kind of failure or suboptimal performance to be predicted or detected is known to have occurred. These ‘known positive’ datasets are used alongside a random selection of ‘known negative’ datasets to drive machine learning in a classic supervised machine learning scenario.

Machine learning module 145 is then programmed to use the parameters to perform machine learning algorithms on the collective dataset to generate a prediction model. Different embodiments of prediction model engine 105 use different machine learning algorithms to generate the prediction model. In some embodiments, more than one algorithm is used to produce more accurate prediction model. Prediction model manager 135 continues to optimize the parameters for the data pattern models and feed the optimized parameters (and updated data pattern models) into the prediction model to improve its performance.

Once the prediction model is generated, prediction model engine 105 is programmed to execute the prediction model on new sensor data retrieved from sensor modules 130a-130f (preferably in real-time). Using the prediction model, prediction model engine 105 is programmed to detect and determine a status of physical system 110 based on the newly retrieved sensor data.

The detected status of physical system 110 can be used in many ways. For example, prediction model engine 105 of some embodiments is also communicatively coupled with elements 165a-165c of physical system 110. Each of elements 165a-165c are configurable to different settings. For example, element 165a can be a pump, which can be configured to different power levels, different speed levels, different flow levels, etc. Element 165b can be a valve that can be configured to open or shut, and different flow levels. Element 165c can be a boiler that can be configured to different heat levels.

In some embodiments, prediction model engine 105 is programmed to configure the different elements (e.g., elements 165a-165c) of physical system 110 based on the status of physical system 110 detected by machine learning module 145. In some of these embodiments, prediction model engine 105 is programmed to configure elements 165a-165c by sending control signals to elements 165a-165c.

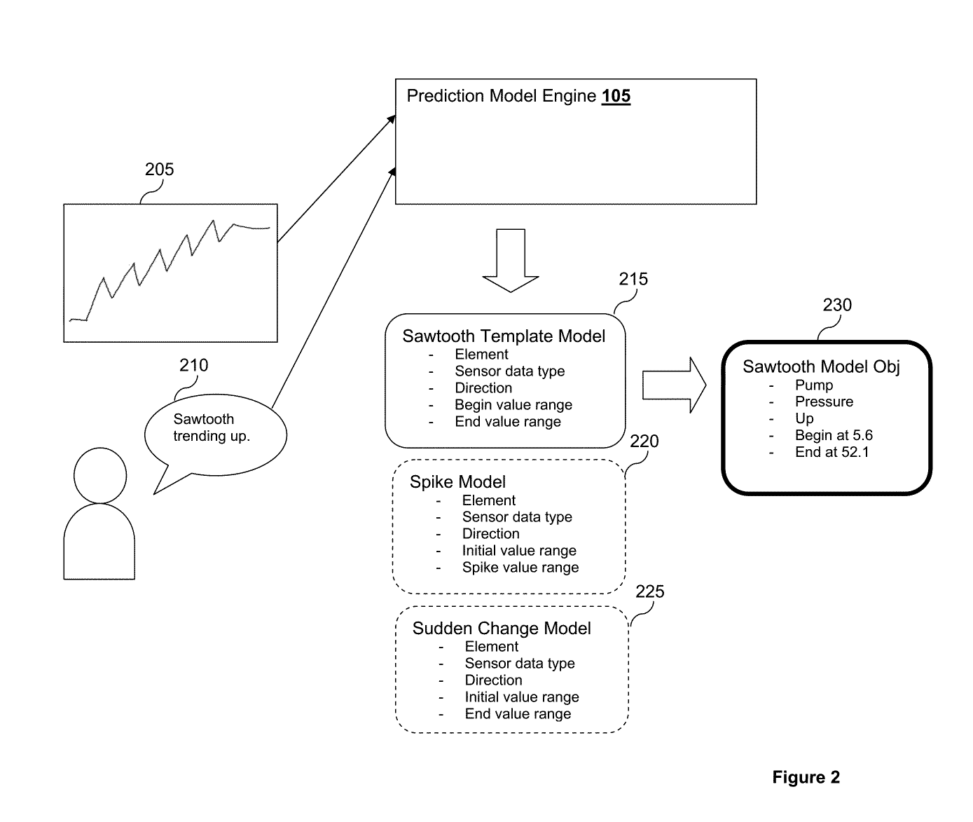

FIG. 2 shows how prediction model engine 105 uses the formal language to produce parameters that are fed into machine learning algorithms in more detail. Specifically, FIG. 2 illustrates that prediction model engine 105 is presenting a graph 205 representing sensor data retrieved from at least one of the sensor modules 130a-130f. In this example, graph 205 shows the sensor data forming a saw-tooth pattern over a period of time. As shown, the sensor data also has an overall trend of increasing in value, where the sensor data is approximately at around value ‘a’ immediately prior to the saw-tooth pattern, and ends approximately at around value ‘b’ immediately after the saw-tooth pattern.

As prediction model engine 105 is presenting the graph 205, prediction model engine 105 is configured to obtain description input from subject matter expert 125. In this example, subject matter expert 125 provides description input 210 in a verbal form, by way of speaking out the phrase “saw-tooth trending up,” as subject matter expert 125 is viewing graph 205 on the screen.

Once obtained description input 210, prediction model engine 105 enumerates the many data pattern template models in database 115 and determines a template model that best fit the description input 210. As mentioned before, each of the data pattern template models includes template attribute-value pairs to describe a particular data pattern. FIG. 2 illustrates the detail of three exemplary data pattern template models—a saw-tooth pattern template model 215, a spike template model 210, and a sudden change template model 215. It is noted that prediction model 105 is not limited to including these three template models and can include many other different template models as well.

Saw-tooth pattern template model 215 includes attributes ‘element,’ ‘data type,’ ‘direction,’ ‘beginning value range,’ and ‘ending value range.’ Attribute ‘element’ represents which element of physical system 110 the sensor data is representing (e.g., a specific pump, a specific valve, etc.), attribute ‘data type’ represents what type of information is collected associated with the element (e.g., pressure data, temperature data, etc.), attribute ‘direction’ represents whether the sensor data is trending up, down, or flat, attribute ‘beginning value range’ represents a range of sensor data value range immediately before the data pattern begins, and attribute ‘ending value range’ represents a range of sensor data value immediately after the data pattern ends.

Spike template model 220 has attributes ‘element,’ data type,′ spike direction,′ ‘beginning value range,’ and ‘spike value range.’ Attribute ‘element’ represents which element of physical system 110 the sensor data is representing (e.g., a specific pump, a specific valve, etc.), attribute ‘data type’ represents what type of information is collected associated with the element (e.g., pressure data, temperature data, etc.), attribute ‘spike direction’ represents whether the data pattern spikes up or down, attribute ‘beginning value range’ represents the sensor data value range immediately before the data pattern begins, and attribute ‘spike value range’ represents the sensor data value range at the peak or trough.

Sudden change template model has attributes ‘element,’ data type,′ direction,′ ‘beginning value range,’ and ‘ending value range.’ Attribute ‘element’ represents which element of physical system 110 the sensor data is representing (e.g., a specific pump, a specific valve, etc.), attribute ‘data type’ represents what type of information is collected associated with the element (e.g., pressure data, temperature data, etc.), attribute ‘direction’ represents whether the sensor data is trending up, down, or flat, attribute ‘beginning value range’ represents a range of sensor data value range immediately before the data pattern begins, and attribute ‘ending value range’ represents a range of sensor data value immediately after the data pattern ends. These attributes only represent exemplary attributes for a model, other attributes for these or other model objects include time, dates, etc.

In addition, these data pattern template models represent only a few exemplary template models. It is contemplated that other data pattern template models that represent other types of data patterns (e.g., step data pattern) or even template models that represent relationships between two different sensor data types. For example, a template model can represent an inverse relationship between a specific pump's pressure and the specific pump's temperature of physical system 110.

Prediction model engine 105 of some embodiments parses description input 210 (e.g., using a tree structure) to arrive at one of the many data pattern template models. In this example, prediction model engine 105 selects saw-tooth pattern template model 215 based on description input 210. In some embodiments, once prediction model engine 105 arrives at a particular template model, prediction model engine 105 instantiates a model object based on the arrived template model. In this example, prediction model engine 105 instantiates a saw-tooth pattern model object 230. In addition, prediction model engine 105 also fills in values to the attributes of this object—it inserts value ‘pump’ for attribute ‘element,’ value ‘pressure’ for attribute ‘data type,’ value ‘up’ for attribute ‘direction,’ value ‘a’ for attribute ‘beginning value range,’ and value ‘b’ for attribute ‘ending value range.’

In some embodiments, before instantiating a new data pattern model object, prediction model engine 105 first determines if there is another data pattern model object that has been instantiated for the same type of element, data type, and data pattern. For example, if prediction model engine 105 determines that a saw-tooth pattern model object has been instantiated for that specific pump and for pressure, instead of instantiating another data pattern model object, prediction model engine 105 updates the existing model object. In these embodiments, prediction model engine 105 is programmed to update values associated with attributes ‘beginning value range’ and ‘ending value range.’

For example, if the beginning values are different on two separate instants in which subject matter expert 125 is describing the same data pattern (same direction) on the same type of sensor data about the same element of physical system 110, prediction model engine 105 can take the average in some embodiments, and can state a range of values that includes both of the beginning values in other embodiments. Prediction model engine 105 can do the same for ending value range or any other attributes that can vary.

As prediction model engine 105 continues to receive description input from subject matter expert 125, prediction model engine 105 will keep instantiating data pattern model objects and/or updating existing data pattern model objects, based on the data pattern type prediction model engine 105 derives from the description input.

Based on the data pattern model objects, prediction model engine 105 estimates a set of parameters to be used in one or more machine learning algorithms. In some embodiments, as prediction model engine 105 receives enough description input and generates model objects that sufficiently representing subject matter expert 125's perspective of physical system 110, prediction model engine 105 can further optimize the parameters. Prediction model engine 105 then feeds the set of parameters to one or more machine learning algorithms to generate a prediction model for physical system 110.

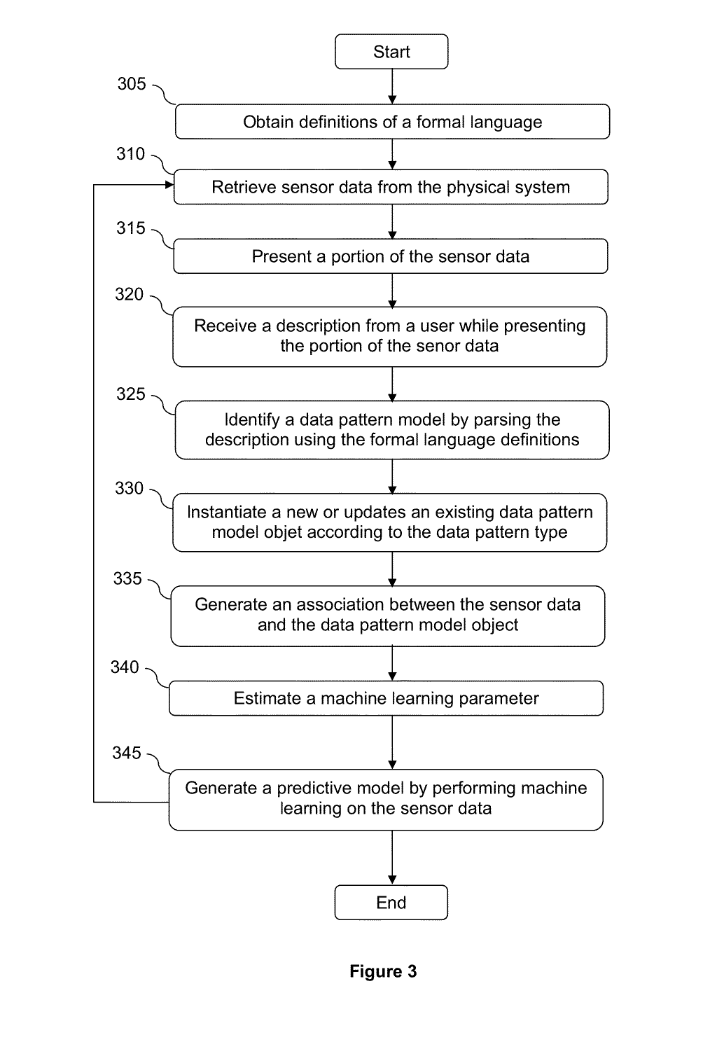

FIG. 3 illustrates a process 300 to generate a prediction model using the methods as described above. The process 300 begins by obtaining (at step 305) formal language definitions that is capable of describing data patterns of a physical system from, preferably, a data scientist. The process 300 then retrieve (at step 310) sensor data from the physical system. As sensor data is being received from the physical system, the process 300 presents (at step 315) a portion of the sensor data to a subject matter expert.

Preferably, the subject matter expert will provide description input when the expert recognizes a data pattern from the portion of sensor data being displayed. Thus, the process 300 receives (at step 320) a description input from the subject matter expert while presenting the portion of sensor data.

The process 300 then identifies (at step 325) a data pattern model by parsing the description using the formal language definitions. Once a data pattern model is identified, the process 300 either (a) instantiates (at step 330) a new data pattern model object that corresponds to the identified data pattern model or (b) updates (at step 330) an existing data pattern model object. The process 300 also generates (at step 335) an association between the data pattern model object and the portion of the sensor data being presented to the subject matter expert. Next, the process 300 estimates (at step 340) a machine learning parameter for the prediction model. The process 300 uses the estimated parameters to perform machine learning on the retrieved data set to generate (at step 345) a prediction model.

In some embodiments, the process 300 performs steps 310-345 repetitively when new sensor data is retrieved. As new parameters are generated, the process 300 continues to update the parameters to the machine learning algorithms. After instantiating and updating sufficient data pattern model objects, the parameters are optimized for the physical system, and the updated prediction model will become more and more accurate as the process continues to learn from updated sensor data and input from subject matter expert.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of generating a predictive model for operation of a physical system, comprising:
obtaining definitions of a formal language capable of describing a plurality of data patterns significant to the operation of the physical system;
monitoring sensor data associated with the physical system over a period of time;
iteratively: (1) displaying a representation of the monitored sensor data to a user via the interface, (2) receiving, via the interface, a description from the user describing the presented sensor data, (3) identifying one data pattern out of the plurality of data patterns by parsing the description using the definitions of the formal language, and (4) generating an association between the identified data pattern and a portion of the sensor data displayed to the user via the interface;
calculating a parameter to be used in a machine learning algorithm based on the generated associations between the data patterns and the different portions of the sensor data; and
generating a predictive model for the operation of the physical system by applying the estimated parameter to the machine learning algorithm.

2. The method of claim 1, wherein the physical system comprises at least one of a machinery, an organic matter, a person.

3. The method of claim 1, wherein the description comprises a noun and a verb.

4. The method of claim 1, wherein the description comprises a noun and an adjective.

5. The method of claim 1, wherein calculating the parameter comprising estimating the parameter based on descriptions and characteristics of associated historical sensor data.

6. The method of claim 1, wherein calculating the parameter comprises deriving the parameter from historical sensor data retrieved at different instances in time, wherein a subset of the historical sensor data is associated with a description of failure or suboptimal performance.

7. The method of claim 1, wherein calculating the parameter comprises estimating the parameter from the description associated with sensor data and optimizing the parameter using a machine learning algorithm.

8. The method of claim 1, further comprising:
applying the predictive model to a set of current sensor data; and
triggering an alert when the predictive model indicates an occurrence of an event.

9. The method of claim 1, further comprising:
applying the predictive model to a set of current sensor data; and
adjusting an operating parameter of a part within the physical system when the predictive model indicates an occurrence of an event.

10. The method of claim 1, wherein the representation of the sensor data comprises a graphical representation of the sensor data.

11. The method of claim 1, further comprising selecting a feature of the sensor data that is significant to the operation of the physical system.

12. The method of claim 11, wherein estimating a parameter comprises estimating the parameter based on the selected features.

13. The method of claim 1, wherein the parameter is a common characteristic of the portions of sensor data.

14. A predictive model generation system for generating a predictive model for a physical system, comprising:
a plurality of sensors configured to obtain environmental data associated with the physical system;
a user interface comprising a display device and an input device;
a database storing a plurality of data pattern templates; and
a predictive engine comprising a processor and memory storing software instructions that when executed by the processor perform the following steps:
obtaining definitions of a formal language capable of describing the plurality of data patterns significant to the operation of the physical system,
iteratively: (1) retrieving sensor data from the plurality of sensors, (2) configuring the user interface to present a representation of the retrieved sensor data to a user, (3) receiving, via the user interface, a description from the user describing the presented sensor data, (4) identifying one data pattern out of the plurality of data patterns by parsing the description using the definitions of the formal language, and (5) generating an association between the identified data pattern and a portion of the sensor data displayed to the user via the user interface,
calculating a parameter to be used in a machine learning algorithm based on the generated associations between the data patterns and the different portions of the sensor data, and
generating a predictive model for the operation of the physical system by applying the estimated parameter to the machine learning algorithm.

15. The system of claim 14, wherein the software instructions further perform the step of calculating the parameter by estimating the parameter based on descriptions and characteristics of associated historical sensor data.

16. The system of claim 14, wherein the software instructions further perform the step of calculating the parameter by deriving the parameter from historical sensor data retrieved at different instances in time, wherein a subset of the historical sensor data is associated with a description of failure or suboptimal performance.

17. The system of claim 14, wherein the software instructions further perform the step of calculating the parameter by estimating the parameter from the description associated with sensor data and optimizing the parameter using a machine learning algorithm.

18. The system of claim 14, wherein the software instructions further perform the steps of:
applying the predictive model to a set of current sensor data; and
triggering an alert when the predictive model indicates an occurrence of an event.

19. The system of claim 14, wherein the software instructions further perform the steps of:
applying the predictive model to a set of current sensor data; and
adjusting an operating parameter of a part within the physical system when the predictive model indicates an occurrence of an event.

20. The system of claim 1, wherein the parameter is a common characteristic of the portions of sensor data.
